(19) United States
(12) Patent Application Publication
(10) Pub. No.: US 2006/0257825 A1
(43) Pub. Date: Nov. 16, 2006

(54) Shooting training system

(76) Inventor: Jason Jennings, Rapid City, SD (US)

Correspondence Address: Gene R. Woodle, 3516 Woodle Drive, Rapid City, SD, 57702, US

(21) Appl. No.: 11/127,325

(22) Filed: May 12, 2005

(51) Int. Cl. F41G 3/26; G09B 19/00; F41A 33/00

(52) U.S. Cl. 434/16

(57) ABSTRACT

A shooting training system which consists of a series of targets which allow a shooter to sight in a gun at one distance for a further distance and to practice shooting at a shorter distance which simulates shooting at a further distance.

### BACKGROUND OF THE INVENTION

1. Field of the Invention

The present invention relates generally to hunting and more specifically to a shooting training system which provides a series of targets for training hunters.

2. Background Information

All around the United States and throughout the world, hundreds of thousands of hunters shoot targets in an effort to prepare themselves for hunting. There are various reasons for practicing on targets. One of the most common reasons is that practice on targets makes a hunter a better shooter and more likely to be a successful hunter.

Another common reason for target shooting is to “sight in” a rifle or pistol. Nearly every gun has its own peculiar configuration which causes a bullet fired from the gun to go in a particular direction which may not be the direction in which the gun was aimed. Sighting in involves firing the gun, usually from a fixed or stable position, several times at some form of target. If the gun has not been sighted in previously, the bullets will hit the target in a group or cluster which is some distance from the aiming point. That is, the bullets will not hit the target at the point on the target at which the shooter was aiming. Nearly all modern guns have adjustable sights such that the sights may be adjusted so that the cluster of shots hits around or close to the aiming point. Thus, sighting in is the process by which the sights of the gun are adjusted, if necessary, such that a bullet fired from the gun is more likely to go where it was aimed.

Another problem faced by nearly every hunter involves adjusting for the trajectory of a bullet. (All references to hunters are intended to include target shooters who may not hunt.) That is, a bullet fired from a gun does not go in a straight line, but because of gravity (and possibly other factors within the gun) the bullet will gradually drop until it hits the ground. To be successful, hunters must account for the movement of a bullet up or down on a vertical plane. (Bullets may also be moved in a horizontal plane by wind, but that is not a consideration of this invention.) Guns, particularly rifles, are usually also sighted in to take into account the vertical movement of a bullet. It is common, for instance, to sight a rifle in at 100 yards such that the bullet will (theoretically at least) hit the aiming point when fired at a target from 100 yards. If a rifle is sighted in at 100 yards, it will most likely shoot high or above the aiming point at 50 yards and shoot low at 200 or greater yards.

In addition to problems hunters face in sighting in their guns, they nearly always face problems relating to firing at targets (which includes game) which are at a distance different that that at which they have practiced on the firing range. Many firing ranges allow for target shooting at 100 yards. A hunter may be competent at hitting a 100 yard target in what might be called the “kill zone.” The kill zone is defined as the portion of a game animal which, if hit by a bullet, will ordinarily result in a clean kill. For example, the kill zone on a deer might be considered a 10 inch circle just behind the front shoulder of the animal. For other animals the kill zone would be of a different size. The kill zone on a turkey might be more like 3 inches than 10 inches. The hunter who could consistently hit the kill zone on a target at 100 yards may be faced with a shot from a much greater distance in the field. If a deer hunter, for instance, is faced with attempting a shot at a deer 400 yards away and the hunter has not practiced at that distance, he or she will be unlikely to hit the deer in the kill zone. The hunter may not have been able to practice at that because at most shooting ranges the hunter can practice at only 100 or 200 yards using conventional targets.

There have been a number of attempts to help hunters simulate field hunting conditions on a target range. The patent to Gaudet (U.S. Pat. No. 738,790; Sep. 15, 1903) discloses a type of target with which a shooter can simulate shooting at long range at a much shorter actual range.

However, this invention requires the use of “specially prepared ammunition with a reduced charge” to accommodate the shorter distance between gun and target. The patent to Curren (U.S. Pat. No. 3,118,674; Jan. 21, 1964) discloses a sighting in target which allows a shooter to sight in a rifle for, for example 200 yards while shooting at a target which is 100 yards away. This invention assumes that the trajectory of a bullet at 100 yards will be higher than the line of sight point at 100 yards. Using the known characteristics of the rifle and the cartridge, the distance between the point at which the actual flight of the bullet intersects a target at 100 yards and the line of sight aiming point is calculated. The target includes a line of sight bull's eye which is lower than the target bull's eye. The target bull's eye has typical concentric circles around it. The shooter aims at the line of sight bull's eye and measures effect using the target bull's eye.

The shooting training system of the instant invention solves a number of problems facing hunters and others who wish to practice for field conditions or shots longer than the available target range: sighting in the gun, determining accuracy at distances greater than the available range distance, the ability to practice shooting at greater distances than the range distance, sighting in a gun for distances greater than range distance, and practicing hitting the kill zone at any distance.

The ideal shooting training system should provide a method for sighting in a gun. The ideal shooting training system should also provide a method for determining the accuracy of a shooter at distances greater than the available length of a shooting range. The ideal shooting training system should provide a method for practicing shooting at distances greater than the available shooting range distance. The ideal shooting training system should provide a method of sighting in a gun for distances greater than the available range distance. The ideal shooting training system should also provide a method for practicing hitting the kill zone of game at any distance. The ideal shooting training system should also be simple, inexpensive, and easy to use.

### SUMMARY OF THE INVENTION

The shooting training system of the instant invention is an integrated target system for preparing hunters for shooting game in the field on a shooting range which is shorter than many shots will be in the field.

The first of the five targets is a sighting in target for sighting in a gun (usually a rifle) at a distance available at most shooting ranges. The second target is used to determine the accuracy of the shooter and her weapon at distances greater than that available at the shooting range and consists of a series of concentric circles. This target assumes that the kill zone of a game animal will remain the same no matter what the distance from the shooter. The kill zone for a deer, for instance, might be a 10 inch circle. For a deer the target provides a 10 inch circle to simulate hitting the kill zone at 100 yards and, for example, a 3.33 inch circle to simulate the kill zone at 300 yards. The size of the kill zone could be adjusted to simulate game larger or smaller than deer.

The third target includes a number of circles none of which enclose another. The target includes separate circles which simulate the same size kill zone at different distances. The kill zone for a deer, for instance, at 200 yards is five inches in diameter and at 500 yards is two inches in diameter. The fourth target allows the shooter to sight in his rifle for distances greater than available at a typical shooting range. This target provides a scale which may be used with known ballistics information. If, for example, a particular rifle and cartridge were known to shoot a half inch high at 100 yards and two inches low at 200 yards, the shooter could shoot at the bull's eye of the target and adjust the sights until the bullet hit the target an inch and a half high. Thus, if the shooter then shoots at a target or game 200 yards away, the bullet should strike at the aim point. The final target allows the shooter to practice shooting at a target with the appropriate size kill zone at any distance.

One of the major objects of the present invention is to provide a shooting training system which provides a method for sighting in a gun.

Another objective of the present invention to provide a method for determining the accuracy of a shooter at distances greater than the available length of a shooting range.

Another objective of the present invention is to provide a method for practicing shooting at distances greater than the available shooting range distance.

Another objective of the present invention is to provide a method of sighting in a gun for distances greater than the available range distance.

Another objective of the present invention is to provide a method for practicing hitting the kill zone of game at any distance.

Another objective of the present invention is to provide a shooting training system which is simple, inexpensive, and easy to use

These and other features of the invention will become apparent when taken in consideration with the following detailed description and the drawings.

### BRIEF DESCRIPTION OF THE DRAWINGS

FIG. 1 is side view of a method for determining the simulated size of a distant target projected onto a closer target,

FIG. 2 is the sighting in target of the shooting training system,

FIG. 3 is the ability check target of the instant invention,

FIG. 4 is the simulated kill zone target of the instant invention,

FIG. 5 is the distance sighting in target of the instant invention, and

FIG. 6 is the any distance target of the instant invention.

### DESCRIPTION OF A PREFERRED EMBODIMENT

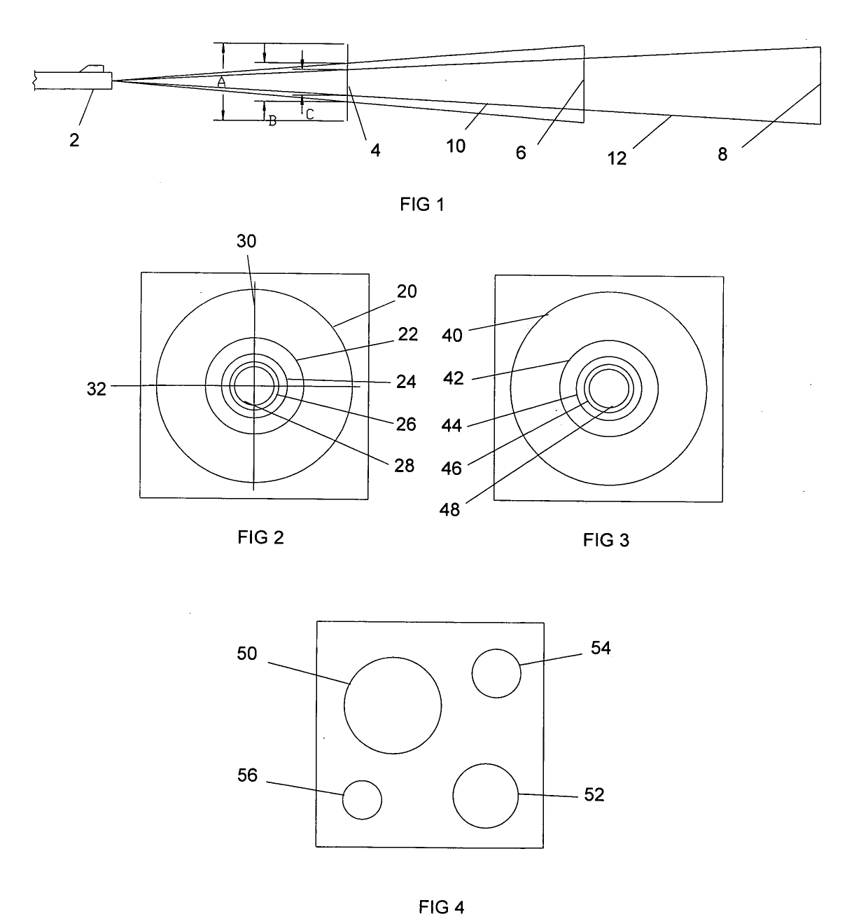

Referring to the drawings, FIGS. 1 through 6, there is shown a preferred embodiment of the shooting training system of the instant invention. The instant invention is an integrated system of five targets intended to prepare a hunter (or long distance target shooter) for field hunting conditions in which it is likely that some game (or targets) will be farther away than the distance at which the hunter could practice at most shooting ranges.

Now referring to FIG. 1, a method for determining the simulated size of a distant target projected onto a closer target is shown. This phenomenon is used in most of the system targets described below. A gun 2 could fire a bullet toward a target A4 at a known distance from the gun 2, or a target B6 which is at twice the distance from said gun 2 as is target A4, or a target C8 which is at three times the distance from said gun 2 as is said target A4. Assuming that all three targets are the same size, the relative size of target B6 may be projected upon said target A4 by lines 10, and the relative size of target C8 may be projected upon said target A4 by lines 12. Thus, the size of said target A4 is represented by dimension A, the relative size of said target B6 projected upon said target A4 is represented by dimension B, and the relative size of said target C8 projected upon said target A4 is represented by dimension C. Using actual measurement with, for instance, a computer aided design program or simple mathematics dimensions A, B, and C are easy to determine. If, for example, said target A4 was 100 yards from said gun 2, said target B6 would be 200 yards from said gun 2, and said target C8 would be 300 yards from said gun 2. If dimension A were 10 inches, dimension B would be 5 inches, and dimension C would be 3.33 inches. In this example, targets at distances greater than said target C8 would be of the following sizes if projected upon said target A4: 400 yards, 2.5 inches; 500 yards, 2 inches; 600 yards, 1.67 inches; 700 yards, 1.43 inches; 800 yards, 1.25 inches; 900 yards, 1.11 inches; and 1000 yards, 1 inch.

Still referring to FIG. 1, the kill zone is considered the area on a game animal which, if hit by a hunter, ordinarily results in a quick, clean kill of the animal. With a deer, for instance, the kill zone might be considered a 10 inch circle just behind the animal's front shoulder. Most hunters will aim for the center of the kill zone. Said target A4 is a 10 inch diameter circle in the above example and is considered to represent the kill zone on a deer. It will be understood that although deer are used in this example, the target sizes could easily be adjusted to accommodate animals having kill zones of different sizes. The same process and method could also be easily adjusted to allow for targets at different distances from said gun 2 than those described above, for example, 150 yards.

Referring now to FIG. 2, the sighting in target of the shooting training system of the instant invention is shown. The sighting in target consists of a series of concentric circles, circle 20, circle 22, circle 24, circle 26, and circle 28, which are generally centered within the target. In this example, circle 20 is 10 inches in diameter, circle 22 is 5 inches in diameter, circle 24 is 3.33 inches in diameter, circle 26 is 2.5 inches in diameter, and circle 28 is 2 inches in diameter. In this example, said circle 20 represents the kill zone of a deer at 100 yards and the target is intended to be used at 100 yards. The target also includes a vertical line 30 which passes vertically through the center of the target and a horizontal line 32 which passes horizontally through the center of the target. This target is intended to be used in a conventional manner to sight in a gun. That is, the shooter fires a number of bullets at the center of the target, ordinarily from a fixed or stable position such that the gun does not move. Ordinarily the bullets will hit the target in a group or cluster. The shooter may then adjust the sights of the gun until the group or cluster of bullet holes are at the center of the target. The gun is then sighted in at 100 yards.

Referring now to FIG. 3, the ability check target of the instant invention is shown. The ability check target consists of a series of concentric circles, circle 40, circle 42, circle 44, circle 46, and circle 48, which are generally centered within the target. In this example, circle 40 is 10 inches in diameter, circle 42 is 5 inches in diameter, circle 44 is 3.33 inches in diameter, circle 46 is 2.5 inches in diameter, and circle 48 is 2 inches in diameter. Said circle 40 represents the kill zone of a deer at 100 yards. Said circle 42 represents the kill zone of a deer at 200 yards. Said circle 44 represents the kill zone of a deer at 300 yards. Said circle 46 represents the kill zone of a deer at 400 yards. Said circle 48 represents the kill zone of a deer at 500 yards. The shooter may shoot at this target to determine whether he and his rifle are accurate enough to shoot at a deer at the various distances represented by the various circles on the target. If, for example, the shooter fires at the target and gets all bullets within said circle 44, but some are not within said circle 46; the shooter may confidently shoot at a deer at 300 yards, should probably not fire at a deer at a greater distance without further practice. That is, for example, if a shooter can not place her shots within said circle 48, she should not shoot at a deer which is more than 400 yards away. It will be understood that different sized circles could be used to simulate the kill zone for animals different sizes than deer or for different distances such as 50 yards.

Referring now to FIG. 4, the simulated kill zone target of the instant invention is shown. This target also consists of a series of circles having different diameters, but none of the circles are within or touch any other circle. Circle 50 is 5 inches in diameter, circle 52 is 3.33 inches in diameter, circle 54 is 2.5 inches in diameter, and circle 56 is 2 inches in diameter. As in the above descriptions, circle 50 represents the kill zone of a deer at 200 yards, circle 52 represents the kill zone of a deer at 300 yards, circle 54 represents the kill zone of a deer at 400 yards, and circle 56 represents the kill zone of a deer at 500 yards. A shooter may shoot at any of the circles in this target to practice shooting at a deer from a particular distance. For instance, the shooter could shoot at said circle 54 to practice shooting at a deer which is 400 yards away. With this, and the other targets described above, to a shooter shooting at the target 100 yards away; the circles appear exactly the same size as a 10 inch target would appear at the listed distance. For instance, said circle 54 looks exactly the same size to the shooter at 100 yards as a 10 inch circle would look at 400 yards. In addition to helping the shooter practice shooting at different distances from a shorter range, shooting at this and the above described targets will also help the shooter to estimate the distance of an actual animal in the field. Because the shooter has practiced shooting at, for example, said circle 52 and knows that is the size of the kill zone on a deer at 300 yards; the shooter will recognize that a deer in the field with approximately same sized kill zone will be about 300 yards away. Again, it will be understood that different sized circles could be used to simulate the kill zone for animals different sizes than deer or for different distances such as 50 yards.

Referring now to FIG. 5, the distance sighting in target of the instant invention is shown. Although the target in FIG. 1 described above may be used to sight in a gun at 100 yards, many shooter desire to sight in their gun at a different distance. For example, a rifle sighted in at 100 yards will most likely shoot low at 200 yards. That is, if a shooter with a rifle sighted in at 100 yards aims at the center of a target which is 200 yards away, it is likely that the bullet will hit below the aiming point, because the bullet is pulled down by gravity as it gets further from the rifle. The ballistics or trajectory of nearly every combination of gun and cartridge is known. Using the distance sighting target of the instant invention with this known ballistics information, a gun may be sighted in for various distances even though the target is set at a fixed distance. The distance sighting target includes a distance vertical line 60, a distance horizontal line 62, and a circle 64 all of which are centered with the target. A scale 66 is also provided which is horizontally centered, but which projects upward from the center of the target. The scale 66 may be in any convenient units, but in the preferred embodiment goes from 0 at the center of the target to 4.5 inches in ¼ inch increments. If, for instance, a shooter wanted to sight in his rifle for 200 yards using the distance sighting in target placed at 100 yards; the shooter would look up the ballistics of his particular weapon and cartridge for 100 and 200 yards. If the rifle shot a half inch high at 100 yards and 2 inches low at 200 yards, the shooter would shoot repeatedly at the center of the target and adjust the sights until the bullets hit 1½ inches high on said scale 66. Then, if the shooter shot at the center of a target 200 yards away, the bullet would hit the center of the target (barring conditions such as wind, elevation, or cartridge loads). Using a similar method, any gun could be sighted in for any reasonable distance using the distance sighting in target of the instant invention.

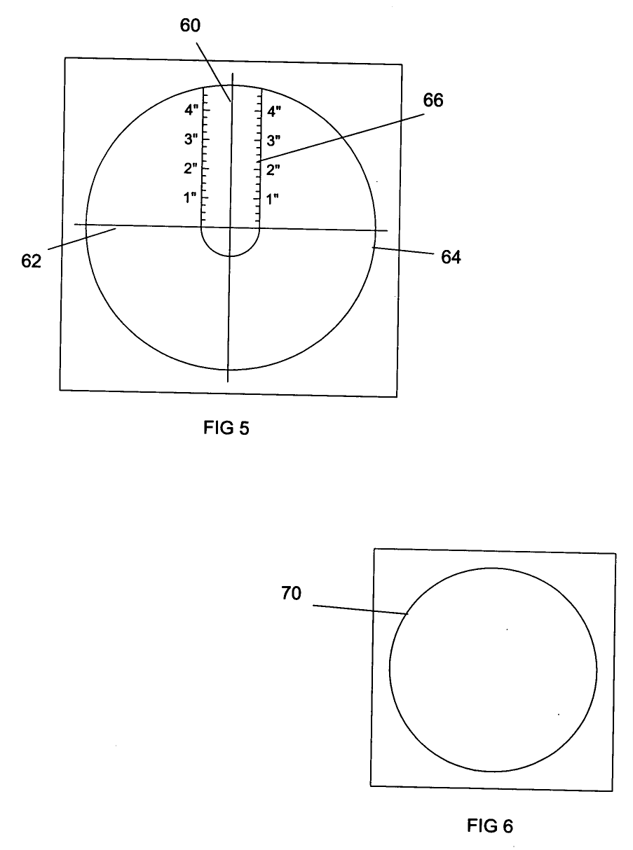

Referring now to FIG. 6, the any distance target of the instant invention is shown. This target is simply a circle 70 having the diameter of the kill zone of the particular animal which may be hunted. For example, with a deer, the circle 70 might be 10 inches in diameter. The shooter may place this target at any distance to practice shooting at the kill zone of the animal.

In all embodiments, the shooting training system of the instant invention is made up of targets printed on relatively thick, stiff paper; but other materials such as plastic could be used.

While preferred embodiments of this invention have been shown and described above, it will be apparent to those skilled in the art that various modifications may be made in these embodiments without departing from the spirit of the present invention. That is, the arrangement of holes and slots and the sizes of holes and slots could easily be varied to provide for removal of various casings at different zones.

I claim:

1. A shooting training system to allow a shooter shooting at one distance to simulate hitting a target at a different distance comprising:
(1) a target having at least one circle, the circle having the appropriate size that, at the distance the shooter is shooting, the circle appears to be the size it would appear if it were actually at the distance the shooter desires to practice shooting;
whereby the shooter may place a target at one distance and shoot at said circle to simulate shooting at the same sized circle placed at a different distance.

2. A shooting training system to allow a shooter shooting at one distance to simulate hitting a target at a greater distance comprising:
(1) a target having one large circle;
(2) a plurality of concentric circles within the large circle, each of the concentric circles being of appropriate size that they are the size said large circle would appear to be if said large circle were at different distances from the target each of said concentric circles representing the appearance of said large circle at some different distance;
whereby the shooter may place said target at one distance and simulate shooting at a target set at different distances.

3. The shooting training system of claim 1 in which there is a vertical line and a horizontal line through the center of said target.

4. The shooting training system of claim 2 in which there is a vertical line and a horizontal line through the center of said target.

5. The shooting training system of claim 2 in which the plurality of concentric circles are not concentric, but are not within any other circle.

6. A shooting training system to allow a shooter to sight in a rifle for a further distance while actually shooting at a closer distance comprising:
(1) a target having a center point; and
(2) a scale on the target protruding upward from the center point, the scale capable of measuring the distance from said center point;
whereby a shooter may shoot at said center point of said target at one distance and, knowing the amount the bullet will drop to the further distance, adjust the sights of the gun until bullets fired from the gun hit said target the distance above said center point which the bullet will drop to the second distance as measure by said scale.
